(19) United States
(12) Patent Application Publication
(10) Pub. No.: US 2011/0177412 A1
(43) Pub. Date: Jul. 21, 2011

(54) POWERING METHOD AND POWERING DEVICE OF FUEL CELL

(75) Inventors: Kuo-Tai Hung, Hsinchu County (TW); Cheng Wang, Hsinchu County (TW)

(73) Assignee: YOUNG GREEN ENERGY CO., HSINCHU COUNTY (TW)

(21) Appl. No.: 12/978,390

(22) Filed: Dec. 23, 2010

(30) Foreign Application Priority Data
Jan. 15, 2010 (CN) 201010002985.3

(51) Int. Cl. H01M 8/06

(52) U.S. Cl. 429/427

(57) ABSTRACT

A powering method of a fuel cell includes following steps. A fuel cartridge including a plurality of fuel units and an accumulator is provided. An under-load electric quantity of the accumulator is detected. If the under-load electric quantity is less than a threshold, power is supplied by the accumulator to a load. If the under-load electric quantity is greater than the threshold, a first fuel unit of the fuel units is selected and triggered to provide fuel which converted into the power. If the fuel of the first fuel unit is not enough to supply the power to the load, a second fuel unit of the fuel units is selected and triggered to provide the fuel. If the load is removed, the other fuel units which are not yet triggered are not triggered, and the accumulator is charged with the power converted from the fuel.

### CROSS-REFERENCE TO RELATED APPLICATION

This application claims the priority benefit of P.R. China application serial no. 201010002985.3, filed on Jan. 15, 2010. The entirety the above-mentioned patent application is hereby incorporated by reference herein and made a part of specification.

### BACKGROUND OF THE INVENTION

1. Field of the Invention

The invention relates to a fuel cell. More particularly, the invention relates to a powering method and a powering device of a fuel cell.

2. Description of Related Art

Development and application of energy are always indispensable in our daily lives, while development and application of energy sources lead to increasing environmental destruction. Fuel cell-based power generation characterized by high efficiency, low noise, and non-pollution complies with the energy-saving trend.

The most commonly known fuel cell basically has a fuel cartridge, a fuel cell power generation portion, and a secondary battery. The fuel cell power generation portion supplies electric power. The fuel cartridge provides the fuel cell power generation portion with hydrogen gas (H₂) required for electric power generation, such that the fuel cell power generation portion could charge the secondary battery.

Generally, the conventional fuel cartridge adopts one-time response boron-based compound hydrogen storage technology, and water (H₂O) is added to the boron-based compound for chemical reaction, so as to constantly generate the hydrogen gas and supply the same to the fuel cell. However, the conventional fuel cartridge is designed to merely have one large chamber, and the boron-based compound hydrogen storage technology applied in the conventional fuel cartridge results in the one-time chemical reaction. Accordingly, the hydrogen gas is constantly formed until the chemical reaction of NaBH₄ and water is completed.

It could be learned from above that excessive fuel in the fuel cartridge is constantly supplied even though the secondary battery is fully charged. The waste of fuel leads to incomplete utilization of the fuel supplied by the fuel cartridge. Additionally, the hydrogen gas may not be properly processed, which is dangerous. Moreover, when there is residual fuel in the fuel cartridge, a user oftentimes retrieves the fuel cartridge manually to prevent leakage of the hydrogen gas, which is inconvenient in use.

### SUMMARY OF THE INVENTION

The invention is directed to a powering method and a powering device of a fuel cell having at least one of the following advantages; preventing hydrogen gas and electricity from wasting and being convenient in use.

Numerous features and advantages of the invention could be better understood by referring to the disclosure herein.

In an embodiment of the invention, a powering method of a fuel cell is provided. In the powering method of the embodiment, a fuel cartridge having a plurality of fuel units is provided, an accumulator is provided, and an under-load electric quantity of the accumulator is detected. Therein, if the under-load electric quantity is less than a threshold value, electric power is supplied by the accumulator to a load; and if the under-load electric quantity is greater than or equal to the threshold value, at least a first fuel unit of the fuel units is selected and triggered to provide fuel. The fuel is converted into electric power to be supplied to the load. If the fuel generated by the at least a first fuel unit is not enough to supply the electric power to the load, at least a second fuel unit of the fuel units is selected and triggered to provide the fuel. If the load is removed, other fuel units which are not triggered are not triggered, and the accumulator is charged by the electric power converted from the fuel.

In an embodiment of the invention, a powering device of a fuel cell is provided. The powering device includes a fuel cartridge, an accumulator, a charging circuit, a fuel cell power generation portion, and a control unit. The fuel cartridge has a plurality of fuel units. The charging circuit is electrically connected to the accumulator. The fuel cell power generation portion is electrically connected to the charging circuit, so as to convert fuel supplied by the fuel cartridge into electric power. The control unit is capable of detecting an under-load electric quantity of the accumulator and controlling the fuel units, the charging circuit, and the fuel cell power generation portion. If the under-load electric quantity is less than a threshold value, the control unit controls the accumulator to supply the electric power to a load. If the under-load electric quantity is greater than or equal to the threshold value, the control unit selects and triggers at least a first fuel unit of the fuel units to provide the fuel cell power generation portion with the fuel for supplying the load with the electric power. If the fuel generated by the at least a first fuel unit is not enough to supply the electric power to the load, the control unit selects and triggers at least a second fuel unit of the fuel units to provide the fuel. If the load is removed, the control unit stops triggering other fuel units and enables the charging circuit to charge the accumulator with the electric power converted from the fuel.

According to an embodiment of the invention, in the powering device of the fuel cell, the accumulator is charged with the electric power converted from the fuel if the electric power is greater than a requirement of the load.

According to an embodiment of the invention, the powering device of the fuel cell further includes a first DC-to-DC converter and a second DC-to-DC converter. The first DC-to-DC converter is electrically connected between the fuel cell power generation portion and the load, and the first DC-to-DC converter is controlled by the control unit to determine whether the electric power is supplied to the load. The second DC-to-DC converter is electrically connected between the accumulator and the load, and the second DC-to-DC converter is controlled by the control unit to determine whether the electric power is supplied to the load.

According to an embodiment of the invention, the fuel supplied by each of the fuel units provides substantially identical electric quantity, and the fuel includes hydrogen.

Based on the above embodiments, the embodiment of the invention has at least one of the following advantages. The fuel cartridge is divided into a plurality of fuel cells, in each of which chemical reaction could take place. Accordingly, the control unit could spontaneously select and trigger one or more of the fuel units based on the electric power required by the load or the electric quantity of the accumulator. Thereby, waste of the hydrogen gas and electricity could be reduced or prevented.

Other objectives, features and advantages of the invention will be further understood from the further technological features disclosed by the embodiments of the invention wherein there are shown and described preferred embodiments of this invention, simply by way of illustration of modes best suited to carry out the invention.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a block view illustrating a powering device of a fuel cell according to an embodiment of the invention.

FIG. 2 is a schematic view illustrating a fuel cartridge of a fuel cell according to an embodiment of the invention.

FIG. 3 is a flowchart illustrating a powering method of a fuel cell according to an embodiment of the invention.

### DESCRIPTION OF EMBODIMENTS

It is to be understood that other embodiment may be utilized and structural changes may be made without departing from the scope of the invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

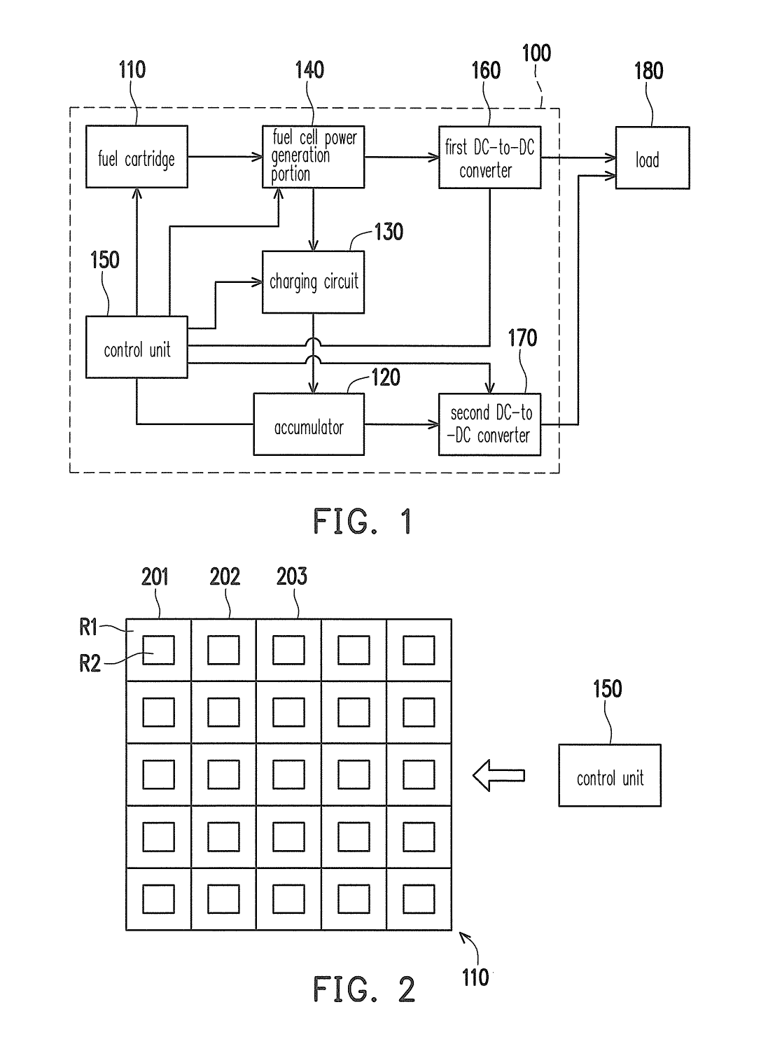

FIG. 1 is a block view illustrating a powering device 100 of a fuel cell according to an embodiment of the invention. As shown in FIG. 1, the powering device 100 of the fuel cell is capable of supplying electric power to a load 180. The powering device 100 of the fuel cell includes a fuel cartridge 110, an accumulator 120, a charging circuit 130, a fuel cell power generation portion (e.g. a fuel cell) 140, and a control unit 150.

The fuel cartridge 110 is capable of generating fuel (e.g. hydrogen gas) to the fuel cell power generation portion 140. The charging circuit 130 is electrically connected to the accumulator 120. The fuel cell power generation portion 140 is electrically connected to the charging circuit 130. Besides, the fuel cell power generation portion 140 converts fuel supplied by the fuel cartridge 110 into electric power, such that the load 180 could be supplied with the electric power converted from the fuel, or that the accumulator 120 could be charged. The control unit 150 is capable of detecting an under-load electric quantity of the accumulator 120 and controlling the operation of the charging circuit 130 and the fuel cell power generation portion 140. In this embodiment, the under-load electric quantity is defined by subtracting residual electric quantity of the accumulator 120 from the electric quantity of the fully charged accumulator 120. For instance, the total electric quantity of the fully charged accumulator 120 is 5 watt-hour (Whr), and the residual electric quantity of the accumulator 120 is 2 Whr after the accumulator 120 consumes the electric power. As a result, the under-load electric quantity of the accumulator 120 is 5 Whr−2 Whr=3 Whr.

The fuel cell in this embodiment could be a proton exchange membrane fuel cell (PEMFC) or a direct methanol fuel cell (DMFC), which is not limited in this invention. The PEMFC, for example, mainly includes a proton exchange membrane, a cathode, and an anode. Fuel at the anode of the PEMFC reacts with catalyst to generate hydrogen ions (H⁺) and electrons (e⁻), which could be represented by the following chemical formula:

2H₂→4H⁺+4e⁻

Additionally, the generated electrons are transported to the cathode after flowing through circuits (e.g. the load 180). The generated hydrogen ions are supplied to the cathode through the proton exchange membrane in the fuel cell, and the hydrogen ions react with oxygen gas and the electrons at the cathode of the fuel cell to fond water, which may be represented by the following chemical formula:

4H⁺+4e⁻+O₂→2H₂O

To sum up, the complete chemical reaction of the PEMFC could be represented by the following chemical formula:

2H₂+O₂→2H₂O

How to generate electric power in a fuel cell system is well known to people skilled in the art, and therefore no further description is provided herein. The embodiment may be applied to fulfill the powering device 100 of the fuel cell in any form at present or in the future. The fuel cartridge 110 is exemplified in the following embodiments.

FIG. 2 is a schematic view illustrating the fuel cartridge 110 of a fuel cell according to an embodiment of the invention. The fuel cartridge 110 includes a plurality of fuel units, e.g. fuel units 201, 202, and 203. In FIG. 2, the fuel units in the fuel cartridge 110 are exemplarily arranged in a 5×5 array. In other embodiments, however, the number and the arrangement of the fuel units in the fuel cartridge 110 may be different from those depicted in FIG. 2. For instance, the fuel units may be arranged in a honeycomb-shaped manner, in a linear manner, in a three-dimensional stacked manner, and so on. Each of the fuel units has a chamber where a first reactant and a second reactant are disposed. The exemplary fuel unit 201 has a first reactant R1 and a second reactant R2. The relevant description of the fuel unit 201 may be applied to other fuel units.

The first reactant R1 may be any hydrogen-containing reactant or any chemical hydrogen storage material, e.g. water (H₂O), which should not be construed as a limitation to this invention. The second reactant R2 may be any hydrogen-containing reactant or any chemical hydrogen storage material in a solid form or in a liquid form, e.g. NaBH₄, LiH, and so forth, which should not be construed as a limitation to this invention. According to some embodiments, the first reactant R1 may be NaBH₄, and the second reactant R2 may be water. The first reactant R1 and the second reactant R2 are separated from each other by a separation film. The separation film may be made of any material (e.g. plastic) as long as the separation film does not chemically or physically react with the first reactant R1 and the second reactant R2. The separation film may separate the first reactant R1 and the second reactant R1 and R2 in any fashion. For instance, the chamber of the fuel unit 201 may be separated into two sub-chambers respectively having the first reactant R1 and the second reactant R2. In an alternative, the separation film may completely enclose the second reactant R2, such that the first reactant R1 and the second reactant R2 do not come into contact with each other.

In this embodiment, when the first reactant R1 comes into contact with the second reactant R2, the chemical reaction therebetween includes but is not limited to the following:

[CH₃N(H)BH₂]3→[CH₃NBH]₃+3H₂; 1.

nNH₄X+4MHₙ→Mxₙ+M₃Nₙ+4nH₂; 2.

N₂H₆X₂+8/nMHₙ→2/nMxₙ+2/nM₃Nₙ+7H₂; 3.

(NH₄)₂SO₄+16/nMHₙ→4M_{2/n}O+M_{2/n}S+2/nM₃Nₙ+12H₂; 4.

N₂H₆SO₄+16/nMHₙ→4M_{2/n}O+M_{2/n}S+2/nM₃Nₙ+11H₂; 5.

LiBH₄→LiH+B+(3/2)H₂; 6.

Ni+2H₂O→Ni(OH)₂+H₂; and 7.

NaBH₄+2H₂O→NaBO₂+4H₂ 8.

In this embodiment, the fuel supplied by each of the fuel units 201, 202, and 203 provides substantially identical electric quantity, and the electric quantity provided by one of the fuel units is assumed to be 2 Whr, which is not limited in this invention. The electric quantity of the fully charged accumulator 120 is assumed to be 5 Whr. In this embodiment, the total electric quantity of a single fuel unit is less than the electric quantity of the fully charged accumulator 120, while the total electric quantity of a single fuel unit may be equal to the electric quantity of the fully charged accumulator 120 in other embodiments.

The control unit 150 is electrically connected to all of the fuel units for controlling the fuel units. When the powering device 100 of the fuel cell operates, the control unit 150 detects the under-load electric quantity of the accumulator 120. Namely, whether the residual electric quantity of the accumulator 120 allows the accumulator 120 to further store the electric power generated by one or more of the fuel units. For instance, when the total electric quantity of the fully charged accumulator 120 is assumed to be 5 Whr, and the residual electric quantity of the accumulator 120 is 4 Whr, the under-load electric quantity of the accumulator 120 approximates 1 Whr. If the residual electric quantity of the accumulator 120 is 2 Whr, the under-load electric quantity of the accumulator 120 approximates 3 Whr. If the under-load electric quantity is detected to be less than a threshold value (e.g. the total electric quantity generated by a single fuel unit), and the threshold value is 2 Whr, for example, the control unit 150 controls the accumulator 120 to supply the electric power to the load 180.

On the other hand, the accumulator 120 constantly consumes electric power. When the control unit 150 detects the under-load electric quantity of the accumulator 120 to be greater than or equal to the threshold value, the control unit 150 selects and triggers at least a first fuel unit (e.g. the fuel cell 201) of the fuel units to supply fuel (e.g. hydrogen) to the fuel cell power generation portion 140. The fuel cell 201 is triggered by the control unit 150. Specifically, the control unit 150 triggers a servo device to destroy the separation film between the first reactant R1 and the second reactant R2. The servo device could include a heating apparatus (e.g. an electric heating wire), a needle mechanism, or other physical destruction mechanisms. When the separation film of the fuel unit 201 is destroyed, the first reactant R1 and the second reactant R2 in the fuel unit 201 come into contact for chemical reaction, and thereby fuel (e.g. hydrogen) is generated and supplied to the fuel cell power generation portion 140. The fuel cell power generation portion 140 then converts the fuel into electric power to be supplied to the load 180.

If the first reactant R1 or the second reactant R2 in the fuel unit 201 is going to run out, the fuel supplied by the fuel unit 210 is gradually decreased. When the fuel generated by the fuel unit 201 is not enough to supply the electric power to the load 180, the control unit 150 selects and triggers at least a second fuel unit of the fuel units (the second fuel unit has not be selected and triggered before, for example, a fuel unit 202) to provide the fuel to the fuel cell power generation portion 140 for constantly supplying the electric power to the load 180.

When the load 180 is removed, the control unit 150 may correspondingly stop selecting and triggering other fuel units (fuel units have not be selected and triggered, for example, the fuel unit 203) and enable the charging circuit 130 to charge the accumulator 120 with the electric power which is converted from the fuel and passes through the charging circuit 130. Accordingly, the control unit 150 may spontaneously select and trigger one of the fuel units or more of the fuel units based on the electric power required by the load 180 or the electric quantity of the accumulator 120. Thereby, waste of fuel (e.g. hydrogen gas) and electricity may be reduced. The control unit 150 enables the charging circuit 130 to charge the accumulator 120 with the electric power that is converted from the fuel and passes through the charging circuit 130 if the electric power converted from the fuel is greater than a requirement of the load 180. Thereby, waste of fuel (e.g. hydrogen) and electricity may be reduced as well.

According to this embodiment, the fuel units 201, 202, 203 . . . are sequentially selected and triggered, which is not limited in this invention. The fuel units may also be selected and triggered in another sequence by request.

Additionally, according to this embodiment, the powering device 100 of the fuel cell further includes a first DC-to-DC converter 160 and a second DC-to-DC converter 170. The first DC-to-DC converter 160 is electrically connected between the fuel cell power generation portion 140 and the load 180, and the first DC-to-DC converter 160 is controlled by the control unit 150 to determine whether the electric power is supplied to the load 180. That is to say, when the control unit 150 enables the fuel cell power generation portion 140 to operate, the first DC-to-DC converter 160 is also enabled to supply the load 180 with the electric power converted by the fuel cell power generation portion 140.

The second DC-to-DC converter 170 is electrically connected between the accumulator 120 and the load 180, and the second DC-to-DC converter 170 is controlled by the control unit 150 to determine whether the electric power is supplied to the load 180. That is to say, when the control unit 150 enables the accumulator 120 to operate, the second DC-to-DC converter 170 is also enabled to supply the electric power of the accumulator 120 to the load 180.

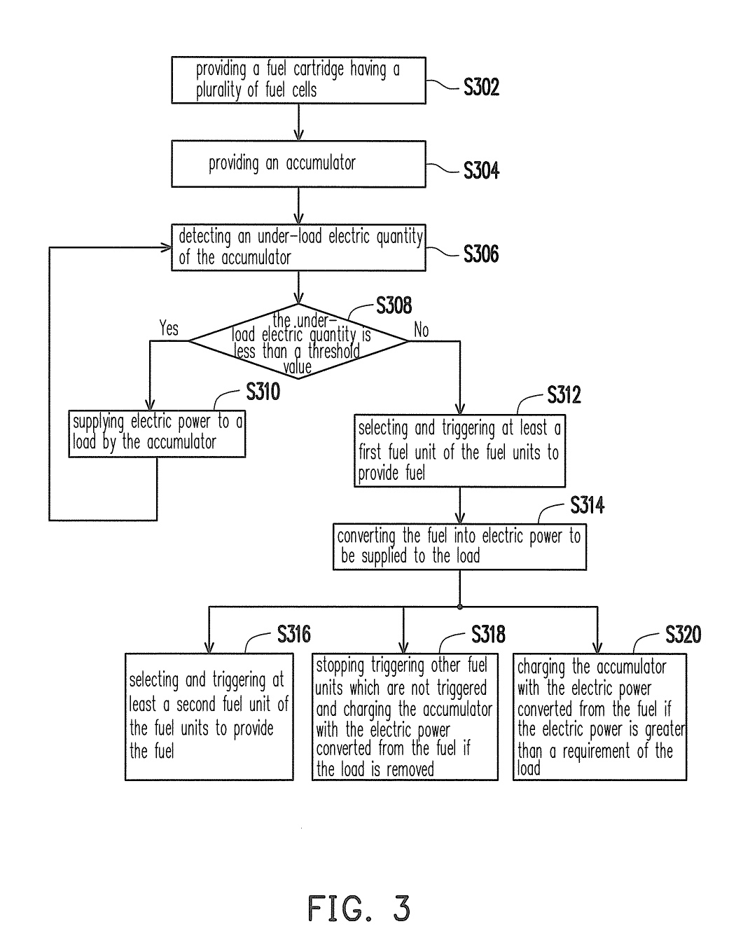

Operation of the powering device 100 of the fuel cell as described above could be described as the following powering method of the fuel cell. FIG. 3 is a flowchart illustrating a powering method of a fuel cell according to an embodiment of the invention. As shown in FIG. 3, a fuel cartridge 110 having a plurality of fuel units is provided in step S302. An accumulator 120 is provided in step S304. In step S306, an under-load electric quantity of the accumulator 120 is detected. For instance, the under-load electric quantity is defined by subtracting residual electric quantity of the accumulator 120 from the electric quantity of the fully charged accumulator 120 after the accumulator 120 consumes the electric power to some extent. In step S308, if the under-load electric quantity is detected to be less than a threshold value, the electric power is supplied to the load 180 by the accumulator 120 in step S310. Step S306˜step S310 are repetitively performed until the under-load electric quantity is greater than or equal to the threshold value. By contrast, if the under-load electric quantity is detected to be greater than or equal to the threshold value in step S308, at least a first fuel unit (e.g. the fuel cell 201) of the fuel units is selected and triggered in step S312 to supply fuel to the fuel cell power generation portion 140.

The fuel is converted into electric power to be supplied to the load 180 in step S314. If the fuel generated by the at least a first fuel unit is not enough to supply the electric power to the load 180, at least a second fuel unit of the fuel units (for example, the fuel unit 202) is selected and triggered in step S316 to provide the fuel to the fuel cell power generation portion 140 for constantly supplying the electric power to the load 180. Back to step 314. If the load 180 is removed in step S318, the other fuel units (for example, the fuel unit 203) are stopped being triggered, and the accumulator 120 is charged with the electric power converted from the fuel. In step S320, the accumulator 120 is charged with the electric power converted from the fuel if the electric power is greater than a requirement of the load 180.

In light of the embodiments of the invention as described above, the fuel cartridge 110 is divided into a plurality of fuel cells, in each of which the chemical reaction could take place. Accordingly, the control unit could spontaneously select and trigger one of the fuel units or more of the fuel units based on the electric power required by the load or the electric quantity of the accumulator 120. Thereby, waste of fuel (e.g. hydrogen gas) and electricity could be reduced or prevented. To sum up, the powering device of the fuel cell as described in the embodiments of the invention at least has one of the following advantages:

1. The fuel cartridge 110 divided into the fuel units may supply the fuel in turns, so as to improve the control of fuel supply and reduce fuel waste.

2. When the fuel waste is reduced, the well-managed fuel supply leads to great security because leakage of hydrogen gas may be prevented.

3. Issues of insufficient fuel, manually supplying the fuel, excessive fuel, and manually retrieving the fuel cartridge 110 may be resolved by using the powering device 100 having the fuel cartridge 110 to spontaneously provide fuel in turn, thus facilitating use of the powering device.

4. The accumulator 120 charges the load 180 when the electric power in the accumulator 120 is sufficient, while the fuel cell power generation portion 140 converts the fuel into the electric power to be supplied to the load 180 when the electric power in the accumulator 120 is insufficient, so as to extend service life of the powering device.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the invention as defined by the following claims. Moreover, no element and component in the present disclosure is intended to be dedicated to the public regardless of whether the element or component is explicitly recited in the following claims.

What is claimed is:

1. A powering method of a fuel cell comprising:
providing a fuel cartridge having a plurality of fuel units;
providing an accumulator;
detecting an under-load electric quantity of the accumulator;
supplying electric power by the accumulator to a load if the under-load electric quantity is less than a threshold value;
selecting and triggering at least a first fuel unit of the fuel units to provide fuel if the under-load electric quantity is greater than or equal to the threshold value;
converting the fuel into the electric power to be supplied to the load;
selecting and triggering at least a second fuel unit of the fuel units to provide the fuel if the fuel generated by the at least a first fuel unit is not enough to supply the electric power to the load; and
stopping triggering other fuel units which are not triggered and charging the accumulator with the electric power converted from the fuel if the load is removed.

2. The powering method as claimed in claim 1 further comprising:
charging the accumulator with the electric power converted from the fuel if the electric power is greater than a requirement of the load.

3. The powering method as claimed in claim 1, wherein the fuel supplied by each of the fuel units provides substantially identical electric quantity.

4. The powering method as claimed in claim 1, wherein the fuel comprises hydrogen.

5. A powering device of a fuel cell comprising:
a fuel cartridge having a plurality of fuel units;
an accumulator;
a charging circuit electrically connected to the accumulator;
a fuel cell power generation portion electrically connected to the charging circuit, so as to convert fuel supplied by the fuel cartridge into electric power; and
a control unit capable of detecting an under-load electric quantity of the accumulator and controlling the fuel units, the charging circuit, and the fuel cell power generation portion, wherein the control unit controls the accumulator to supply the electric power to a load if the under-load electric quantity is less than a threshold value, the control unit selects and triggers at least a first fuel unit of the fuel units to provide the fuel cell power generation portion with the fuel for supplying the load with the electric power if the under-load electric quantity is greater than or equal to the threshold value, the control unit selects and triggers at least a second fuel unit of the fuel units to provide the fuel if the fuel generated by the at least a first fuel unit is not enough to supply the electric power to the load, and the control unit stops triggering other fuel units and enables the charging circuit to charge the accumulator with the electric power converted from the fuel if the load is removed.

6. The powering device as claimed in claim 5, wherein the control unit enables the charging circuit to charge the accumulator with the electric power converted from the fuel if the electric power is greater than a requirement of the load.

7. The powering device as claimed in claim 5 further comprising:
a first DC-to-DC converter electrically connected between the fuel cell power generation portion and the load, the first DC-to-DC converter being controlled by the control unit to determine whether the electric power is supplied to the load; and
a second DC-to-DC converter electrically connected between the accumulator and the load, the second DC-to-DC converter being controlled by the control unit to determine whether the electric power is supplied to the load.

8. The powering device as claimed in claim 5, wherein the fuel supplied by each of the fuel units provides substantially identical electric quantity.

9. The powering device as claimed in claim 5, wherein the fuel comprises hydrogen.
